(19) United States
(12) Patent Application Publication
(10) Pub. No.: US 2009/0028377 A1
(43) Pub. Date: Jan. 29, 2009

(54) DAMPER FOR SPEAKER AND SPEAKER USING THE DAMPER

(76) Inventors: Kimihiro Ando, Mie (JP); Kazuyoshi Umemura, Mie (JP)

Correspondence Address: WENDEROTH, LIND & PONACK L.L.P., 2033 K. STREET, NW, SUITE 800, WASHINGTON, DC, 20006, US

(21) Appl. No.: 12/162,021

(22) PCT Filed: Apr. 3, 2007
(86) PCT No.: PCT/JP2007/057447

§ 371 Date: Jul. 24, 2008

(30) Foreign Application Priority Data
Apr. 4, 2006 (JP) 2006-102696

(51) Int. Cl. H04R 1/00

(52) U.S. Cl. 381/423

(57) ABSTRACT

The present invention realizes a speaker having high sound quality by reducing resonance of curved parts in a speaker damper without decreasing sound pressure and by providing high linearity characteristic. In a damper for a speaker formed by including at least two curved parts, an elastic member is provided at least on one side or on both sides of a peripheral part in a movable part of the damper or provided in the material.

### TECHNICAL FIELD

The present invention relates to a damper for a speaker and a speaker using the same.

### BACKGROUND ART

The technique related to a conventional damper for a speaker and a speaker using the damper will be described with reference to FIG. 4, FIGS. 5A and 5B, and FIGS. 6A and 6B.

FIG. 4 is a cross section of a conventional speaker. In FIG. 4, a magnetic circuit is constructed by plates 43 and 44 and magnet 42. When current according to a sound signal flows in voice coil 41 disposed in a magnetic gap, a force according to the current flowing in voice coil 41 and density of magnetic flux interlinked with voice coil 41 acts on voice coil 41. Since diaphragm 45 is coupled to voice coil 41, it moves integrally with voice coil 41. Diaphragm 45 and voice coil 41 are supported by edge 47 and damper 46, respectively. Edge 47 and damper 46 change their shapes and are movable in the vertical direction, thereby moving diaphragm 45 in the vertical direction and generating sound pressure.

In a general speaker, edge 47 has a large-curve shape which allows large amplitude. The stiffness of edge 47 itself is designed to be low. Since damper 46 supporting voice coil 41 needs high center holding force so as not to be in contact with the magnetic circuit when voice coil 41 vibrates, damper 46 has a shape including a plurality of small curves. Usually, damper 46 is set to have stiffness higher than that of edge 47, and the stiffness of damper 46 is dominant in the whole speaker. One of big factors exerting influence on distortion as a serious drawback of a speaker is nonlinearity caused by fluctuations in the stiffness. From the viewpoint of the distortion performance, it is important that stiffness is constant irrespective of fluctuations in diaphragm 45. Since the stiffness of damper 46 is dominance in that in the entire speaker, the linearity in the vertical direction of damper 46 conspicuously exerts an influence on distortion of the speaker.

FIG. 5A is a plan view of damper 46 of the conventional speaker. FIG. 5B is a cross section taken along line C-C in damper 46. As shown in FIG. 5B, for damper 46, wavy woven or nonwoven cloth in which a plurality of curved parts are formed in cross section and which is impregnated in a thermosetting resin is used.

FIG. 6A is a plan view of another conventional damper 46A. FIG. 6B is a cross section taken along line D-D of damper 46A.

As shown in FIG. 6B, damper 46A has a rise part from a face bonded to a frame and has a plurality of curved parts. Since there is the rise part, a large dimension of contact to the frame, of damper 46A can be realized. Since the distance of the damper from the part bonded to the frame to a part bonded to the voice coil can be made long, the amplitude in the vertical direction of the damper can be made large.

Literature information of known related prior arts is, for example, Unexamined Japanese Patent Publication No. H62-193399 and Tamon Saeki, “Encyclopedia of Speakers and Enclosures”, Seibundo Shinkosha Inc., May 28, 1999, p. 62.

However, the techniques have the following drawbacks. To increase the vertical amplitude of the damper itself, the radius of the curved part has to be increased. When the radius of the curved part is increased, the stiffness is increased by the shape of the curve itself. In a damper having a small diameter, it is difficult to realize increase in the radius of the curved part. Curves may be partly formed large. In this case, symmetry in the vertical direction deteriorates and stress is concentrated on the enlarged curves. There is consequently the possibility that the damper is destroyed from fatigue caused by vertical vibrations.

There is also literature disclosing a method of using, as a damper material, a supporting member obtained by stacking a rubber layer as an elastic member on woven or nonwoven fabric in order to solve the problems. However, the mass of the damper itself increases and, as a result, the mass of the vibration system becomes large. There is a problem that the sound pressure decreases.

### SUMMARY OF THE INVENTION

To solve the problem, in a damper for a speaker of the present invention and a speaker using the damper formed by including at least two curved parts, an elastic member is provided on one side or on both sides of a peripheral part in a movable part of the damper or provided in the material. With the configuration, without increasing the mass of a vibration system, resonance of the damper can be reduced, and sound quality can be improved.

Specifically, in a damper for a speaker and a speaker using the damper of the present invention, an elastic member is provided on one side or on both sides of a peripheral portion in a movable part of the damper formed by including at least two curve parts or provided in a material. The elastic member is not provided in an inner peripheral portion other than the outer peripheral portion. With the configuration, resonance of the curve portion can be reduced. Since the center portion which is coupled to the voice coil is formed by the curve part, without increasing the mass of the vibration system, high sound pressure can be obtained, high linearity is obtained, and distortion can be reduced.

### BRIEF DESCRIPTION OF DRAWINGS

FIG. 1A is a plan view of a damper for a speaker in an embodiment of the present invention;

FIG. 1B is a cross section taken along line A-A of FIG. 1A.

FIG. 2 is a cross section of a speaker using the damper for a speaker of the embodiment;

FIG. 3A is a plan view of a speaker damper having slits as a modification of the embodiment;

FIG. 3B is a cross section taken along line B-B of FIG. 3A;

FIG. 4 is a cross section of a conventional speaker;

FIG. 5A is a plan view of a conventional damper;

FIG. 5B is a cross section taken along line C-C of FIG. 5A;

FIG. 6A is a plan view of another conventional damper; and

FIG. 6B is a cross section taken along line D-D of FIG. 6A.

### DESCRIPTION OF REFERENCE NUMERALS AND SIGNS

10, 10A damper
11, 11A peripheral portion
12, 35 rise part
13 curved part in peripheral portion
14 curved part out of peripheral portion
15 angle of curved part out of peripheral portion
33 curved part having large radius
34 slit

### DETAILED DESCRIPTION OF THE PREFERRED EMBODIMENT

### Embodiment

The present invention will be described by using an embodiment below. The description given in the related art will not be repeated.

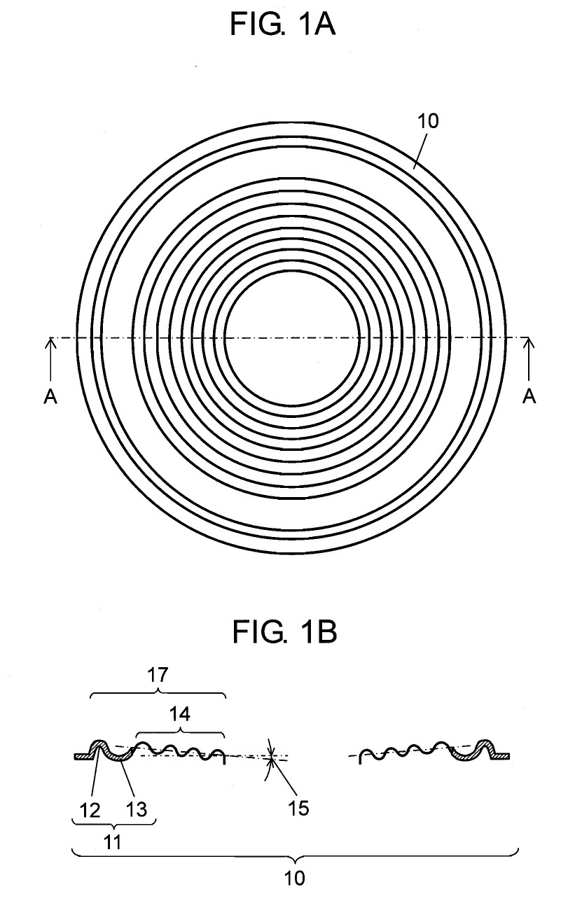

FIG. 1A is a plan view of damper 10 for a speaker in the embodiment of the present invention. FIG. 1B is a cross section taken along line A-A in damper 10.

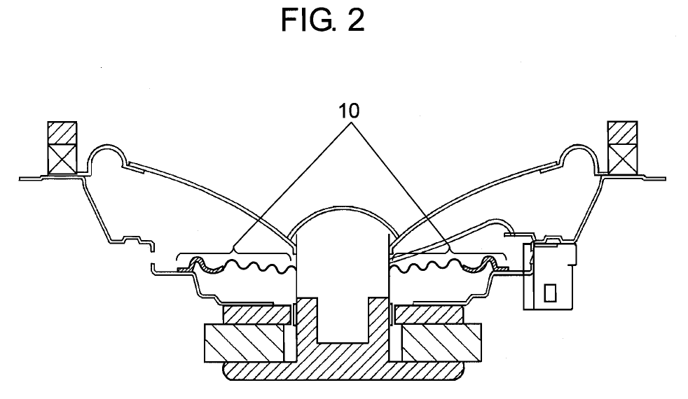

FIG. 2 is a cross section of a speaker using damper 10.

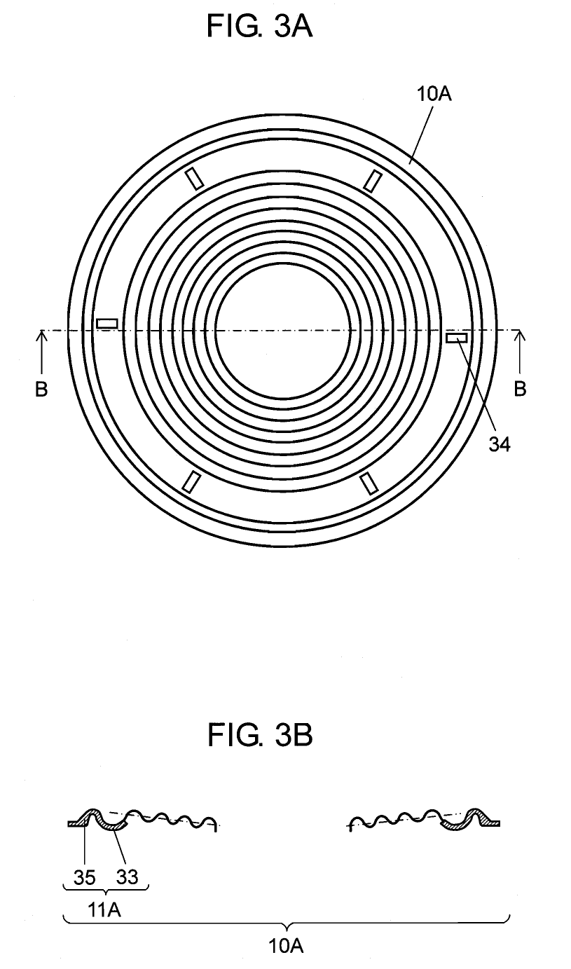

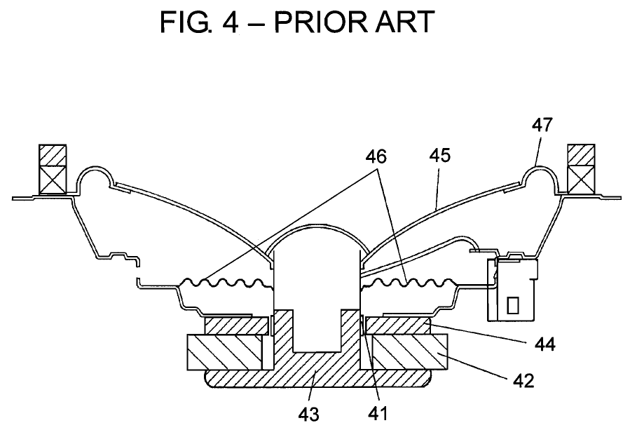

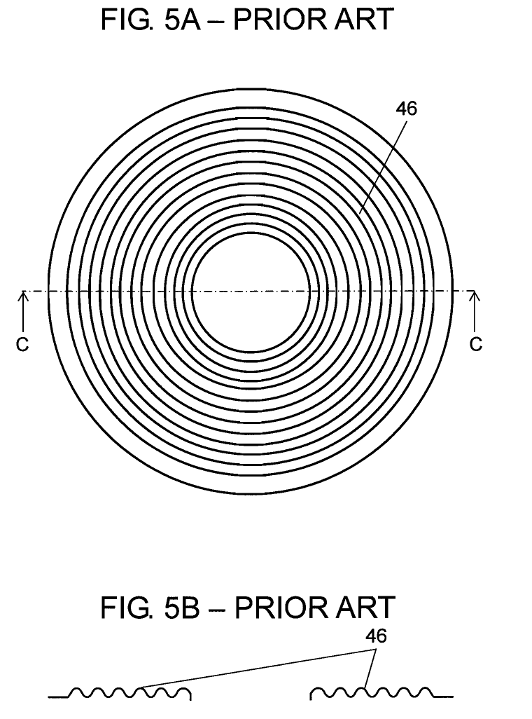

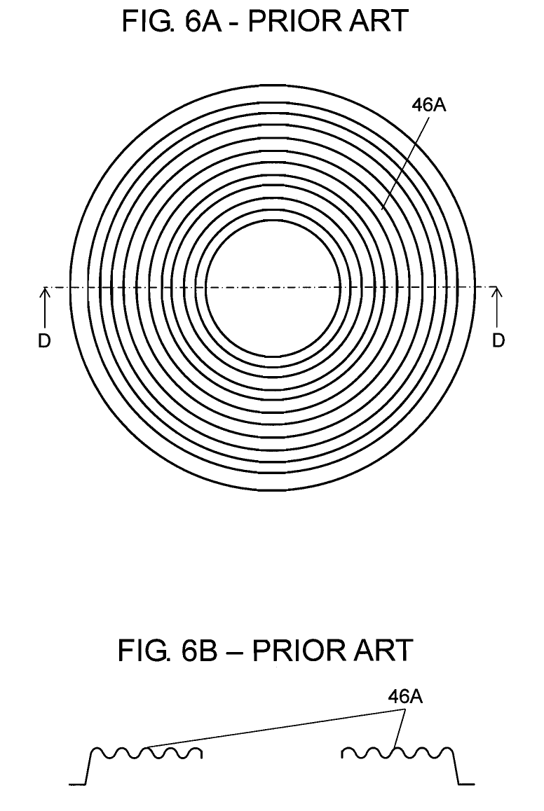

FIG. 3A is a plan view of damper 10A for a speaker, having slits as a modification of the embodiment. FIG. 3B is a cross section taken along line B-B in damper 10A.

As shown in FIGS. 1A and 1B, an elastic member (not shown) is provided on one side or both sides of peripheral portion 11 in movable part 17 of damper 10, formed by two or more curved parts 13 and 14 or provided in the material, and an elastic member is not provided in an inner part other than peripheral portion 11. Rise part 12 is provided in peripheral portion 11 of damper 10. The radius of curved part 13 in peripheral portion 11 is 1.5 times as large as that of curved part 14 out of peripheral portion 11. Further, a rubber (not shown) as an elastic member is coupled, for example, on both sides of large curved part 13 in peripheral portion 11. One of methods of coupling the rubber as the elastic member to a damper made by woven or nonwoven fabric is insert molding for integrally inserting a damper at the time of forming rubber. The rubber may be foamed rubber. In this case, the weight can be reduced. The rubber is coupled on the outer side of the intermediate point between the outermost radius and the inner radius of movable part 17 of damper 10.

Generally, peripheral portion 11 of damper 10 is fixed to the frame by an adhesive. In this case, a part from rise part 12 of damper 10 to a part bonded to the voice coil corresponds to movable part 17 which can move by vibrations of the voice coil.

A regular electrodynamic speaker needs large amplitude in a low sound range, so that damper 10 is requested to have large amplitude and high linearity. In intermediate and high sound ranges, the required amplitude is small but, to generate high sound pressure, it is requested to suppress the mass of a vibration part.

In damper 10 of FIGS. 1A and 1B, at the time of large amplitude in the low sound range, since the radius of curved part 13 in peripheral part 11 is large, by deformation of curved part 13, large amplitude can be obtained. Although there may be stress fatigue in curved part 13 in peripheral part 11 due to large amplitude, since the rubber as the elastic member is disposed on, for example, both sides of curved part 13, excessive vibration or resonance can be reduced. In addition, damper resonance which tends to occur in curved part 13 having a large radius exerts an influence on disturbance of the characteristics of the intermediate sound range. By reducing internal loss resonance of the rubber as the elastic member, the disturbance of the characteristics can be also reduced.

Curved part 13 in peripheral portion 11, having a large radius enables large amplitude to be generated. Curved part 14 on the outside of peripheral portion 11 tends to have asymmetry in the vertical direction when curved part 13 is largely deformed and vibrates. Therefore, by arranging curves so that the centers of the curves draw a locus having an almost cone shape at angle 15 of curved part 14 from the outer periphery toward the inner periphery, the vertical symmetry of curved part 14 out of peripheral portion 11 can be changed. Consequently, in the case where curved part 13 in peripheral portion 11 is a downward curve as shown in FIG. 1B, by forming curved part 14 on the outside of peripheral portion 11 in an inverted cone shape, the vertical symmetry of entire damper 10 can be improved.

As the operations of damper 10 in the intermediate/high sound range, curved part 13 in peripheral portion 11 having small required amplitude and large radius hardly moves, and only curved part 14 on the outside of peripheral portion 11 having the small radius moves. Consequently, the substantial vibration system mass in the mass of damper 10 is the mass of only curved part 14 other than peripheral portion 11, to which the elastic member such as rubber is not attached. The vibration system mass is light, and high sound pressure can be obtained.

FIG. 2 shows the configuration of a speaker using damper 10 of the embodiment. Since the speaker is similar to the conventional speaker described in the related art except for damper 10, the description will not be repeated.

FIG. 3A is a plan view of a damper for a speaker, having slits as a modification of the embodiment. FIG. 3B is a cross section taken along line B-B of the damper.

In damper 10A for a speaker shown in FIGS. 3A and 3B, slits 34 are partly provided in curved part 33 having large radius in peripheral portion 11A of damper 10A. Curved part 33 itself having large radius tends to become hard depending on the material of damper 10A and the aperture of damper 10A, and there is the case that stiffness of curved part 33 becomes asymmetrical in the vertical direction of amplitude. By partly providing slits 34 in curved part 33 having large radius as in damper 10A, stiffness of curved part 33 itself having large radius can be adjusted, asymmetry of stiffness in the vertical direction of amplitude of damper 10A can be easily adjusted, and distortion in the speaker can be reduced. It is expected that, in the case of providing slits 34, the dust proof function in the magnetic gap in damper 10A decreases. However, in the embodiment, by forming notches only in parts made of woven or nonwoven cloth and forming slits 34 simultaneously with molding of an elastic member made of rubber, slits 34 can be closed with the rubber and the magnetic gap can be protected from dusts.

Generally, in a damper having a rise part, in the case where the damper largely vibrates in the vertical direction, the strength of the rise part becomes insufficient, and the rise part is partly bent. It may cause deterioration in sound quality and decrease in reliability. However, in rise part 35 shown in FIG. 3B, by making a thickness of an elastic member coupled to peripheral portion 11A of damper 10A thicker than a thickness of curved part 33, strength of rise part 35 increases. Even when damper vibrates largely, the shape of rise part 35 can be maintained, and sound quality and reliability is also excellent.

### INDUSTRIAL APPLICABILITY

The damper for a speaker and the speaker using the damper of the present invention can be applied as a damper and a speaker requested to realize high sound quality by decreasing resonance of the damper including at least two curved parts and by providing high linearity.

1. A damper for a speaker comprising:
at least two curved parts, wherein an elastic member is provided at least on one side or on both sides of a peripheral portion in a movable part of the damper or provided in a material.

2. The damper for a speaker according to claim 1, wherein the elastic member is provided only for the peripheral portion in the damper.

3. The damper for a speaker according to claim 1, wherein the elastic member is provided on an outer side of an intermediate point between outermost radius and inner radius of a movable part of the damper.

4. The damper for a speaker according to claim 1, wherein the elastic member is made of rubber or foamed rubber.

5. The damper for a speaker according to claim 1, wherein the radius of the curved part in the peripheral portion is 1.5 times as large as that of the curved part out of the peripheral portion.

6. The damper for a speaker according to claim 1, wherein at least one slit is formed in the peripheral portion.

7. The damper for a speaker according to claim 1, wherein curved parts out of the peripheral portion are disposed so that centers of the curved parts draw a locus of a cone shape.

8. The damper for a speaker according to claim 1, wherein a thickness of the elastic member is thicker than a thickness of the part other than the movable part near an outermost periphery of the movable part.

9. A speaker comprising:
a magnetic circuit having at least a magnetic gap;
a frame attached to the magnetic circuit;
a diaphragm whose outer periphery is directly or indirectly coupled to the frame and whose inner periphery is coupled to a voice coil which is fit in the magnetic gap; and
a damper for a speaker according to claim 1, whose outer periphery is coupled to the frame and whose inner periphery is coupled to the voice coil to support the voice coil.

10. A speaker comprising:
a magnetic circuit having at least a magnetic gap;
a frame attached to the magnetic circuit;
a diaphragm whose outer periphery is directly or indirectly coupled to the frame and whose inner periphery is coupled to a voice coil which is fit in the magnetic gap; and
a damper for a speaker according to claim 2, whose outer periphery is coupled to the frame and whose inner periphery is coupled to the voice coil to support the voice coil.

11. A speaker comprising:
a magnetic circuit having at least a magnetic gap;
a frame attached to the magnetic circuit;
a diaphragm whose outer periphery is directly or indirectly coupled to the frame and whose inner periphery is coupled to a voice coil which is fit in the magnetic gap; and
a damper for a speaker according to claim 3, whose outer periphery is coupled to the frame and whose inner periphery is coupled to the voice coil to support the voice coil.

12. A speaker comprising:
a magnetic circuit having at least a magnetic gap;
a frame attached to the magnetic circuit;
a diaphragm whose outer periphery is directly or indirectly coupled to the frame and whose inner periphery is coupled to a voice coil which is fit in the magnetic gap; and
a damper for a speaker according to claim 4, whose outer periphery is coupled to the frame and whose inner periphery is coupled to the voice coil to support the voice coil.

13. A speaker comprising:
a magnetic circuit having at least a magnetic gap;
a frame attached to the magnetic circuit;
a diaphragm whose outer periphery is directly or indirectly coupled to the frame and whose inner periphery is coupled to a voice coil which is fit in the magnetic gap; and
a damper for a speaker according to claim 5, whose outer periphery is coupled to the frame and whose inner periphery is coupled to the voice coil to support the voice coil.

14. A speaker comprising:
a magnetic circuit having at least a magnetic gap;
a frame attached to the magnetic circuit;
a diaphragm whose outer periphery is directly or indirectly coupled to the frame and whose inner periphery is coupled to a voice coil which is fit in the magnetic gap; and
a damper for a speaker according to claim 6, whose outer periphery is coupled to the frame and whose inner periphery is coupled to the voice coil to support the voice coil.

15. A speaker comprising:
a magnetic circuit having at least a magnetic gap;
a frame attached to the magnetic circuit;
a diaphragm whose outer periphery is directly or indirectly coupled to the frame and whose inner periphery is coupled to a voice coil which is fit in the magnetic gap; and
a damper for a speaker according to claim 7, whose outer periphery is coupled to the frame and whose inner periphery is coupled to the voice coil to support the voice coil.

16. A speaker comprising:
a magnetic circuit having at least a magnetic gap;
a frame attached to the magnetic circuit;
a diaphragm whose outer periphery is directly or indirectly coupled to the frame and whose inner periphery is coupled to a voice coil which is fit in the magnetic gap; and
a damper for a speaker according to claim 8, whose outer periphery is coupled to the frame and whose inner periphery is coupled to the voice coil to support the voice coil.
